(19) United States
(12) Patent Application Publication
(10) Pub. No.: US 2013/0053469 A1
(43) Pub. Date: Feb. 28, 2013

(54) INK-JET PRINTER INK

(71) Applicant: Stefan Kappaun, Gross Sankt Florian (AT)

(72) Inventor: Stefan Kappaun, Gross Sankt Florian (AT)

(73) Assignee: DURST PHOTOTECHNIK DIGITAL TECHNOLOGY GMBH, Lienz (AT)

(21) Appl. No.: 13/697,209

(22) PCT Filed: May 10, 2011
(86) PCT No.: PCT/AT2011/000221

§ 371 Date: Nov. 9, 2012

(30) Foreign Application Priority Data
May 10, 2010 (AT) A 788/2010

(51) Int. Cl. C09D 11/10

(52) U.S. Cl. 522/167; 522/178; 524/548; 524/553

(57) ABSTRACT

The invention relates to an ink-jet printer ink comprising polymerizable monomers and/or oligomers and optionally at least one initiator, wherein the monomers and/or oligomers are formed at least up to 65% by weight, preferably exclusively, by at least one, preferably radically polymerizable, vinyl-based compound or the monomers and/or oligomers are formed at least partially, preferably exclusively, by at least one vinyl-based compound and the initiator is formed by monomers which react with the at least one vinyl-based compound during polymerization to form a covalent bond therewith.

The invention relates to an ink-jet printer ink comprising polymerizable monomers and/or oligomers and optionally at least one initiator.

In recent years, UV inks for ink-jet applications have opened up numerous new fields of application, development of the ink-jet business having been driven in particular by the advantages of rapid drying by UV irradiation, the plurality of suitable substrates as well as ecological and economic aspects. In this connection, a major part of the development work on ink-jet inks has been based on acrylates and methacrylates because the associated ink constituents, such as dispersing agents, swellable and reactive monomers, functionalized resins, etc., are commercially available on an industrial scale and are fully characterized. Due to the large number of acrylates and methacrylates available, it is possible to control the adhesion properties on different substrates by opting for a specific mixture of ink ingredients, control resistance to abrasion and solvents or influence the flexibility of cured ink layers, for example. In addition, acrylates and methacrylates can be made to cure rapidly by adding appropriate initiator systems (e.g. UV initiators or thermal initiators), which is why the widespread use of these monomers is not surprising (e.g. in large-format ink-jet printers, as artificial tooth materials, lacquer systems, etc.).

In spite of the frequent use of such monomers, acrylates and methacrylates are attracting an increasing amount of criticism, especially as they usually give off an unpleasant odor before and after curing, which can irritate the eyes, skin and respiratory organs, the amount of energy needed for complete drying is relatively high, inks and cured ink layers are readily flammable and have only limited bio-compatibility (e.g. when used for bone replacement, tooth replacement, implants, etc.). Although it has been possible to address these disadvantages to a certain extent, especially as regards bio-compatibility, by using methacrylates instead of acrylates, making applications such as bone replacement, tooth replacement or implants possible for example, methacrylates generally cure at a lower rate and often exhibit some of the other disadvantages outlined above. There is therefore a strong need for alternative monomer systems.

The underlying objective of this invention is to specify alternative monomer systems for producing ink-jet inks.

This objective is achieved, on the one hand, by means of the ink-jet printer ink outlined above, in which the monomers and/or oligomers are formed at least up to 65% by weight, preferably exclusively, by at least one, preferably radically polymerizable, vinyl-based compound, or the monomers and/or oligomers are formed at least partially, preferably exclusively, by at least one vinyl-based compound and the initiator is formed by monomers which react with the at least one vinyl-based compound during polymerization to form a covalent bond therewith, and on the other hand by the use of at least one vinyl compound from the group of polymerizable vinyl esters, vinyl carbonates, vinyl carbamates, and derivatives thereof and mixtures thereof, to produce an ink-jet printer ink formed at least up to 65% by weight, preferably exclusively, by at least one vinyl-based compound, in particular vinyl esters, vinyl carbonates, vinyl carbamates as well as derivatives thereof and mixtures thereof.

The advantage of this is that these monomers and oligomers may have similar curing, adhesion and stability properties to the acrylates or methacrylates used to date but the disadvantages of the unpleasant odor, irritation of the eyes, skin and rerspiratory organs, the high energy consumption for curing and flammability are addressed, at least for the most part. In addition, these monomers and oligomers exhibit a higher mechanical resistance and significantly higher bio-compatibility and are suitable for producing ink-jet printer inks for a very varied range of applications, including graphic inks, inks for 3D ink-jet printing of implants, bones and replacement teeth or special inks for security features on packaging, medical appliances, etc. The advantage of using these copolymerizable initiators for ink-jet printing applications is that they can be fully bonded in the polymer network of the vinyl-based compounds, in particular vinyl esters, vinyl carbonates and vinyl carbamates, so that the finished printed image or finished print contains, at least for the most part, no extractable initiator decomposition products. The latter is of particular importance in the case of applications in the packaging sector or when making implants, bone or tooth replacements because initiator decomposition products can lead to allergic reactions, for example. Also of particular advantage is the fact that vinyl-based compounds are able fulfill various functions, including acting as a surfactant, binding agent, resin, reagent for ensuring adhesion to the substrate, etc.

The vinyl-based compound or mixtures of several vinyl-based compounds may be contained in a solvent or solvent mixture. It is also possible for at least one of the vinyl-based compounds, for example a vinyl ester, to constitute the solvent or dispersing agent or emulsifying agent for the other components of the ink-jet printer ink.

The copolymerizable initiator used is preferably a photoinitiator.

The monomers and/or oligomers may also be formed at least up to 70% by weight, in particular 80% by weight, by at least one, preferably radically polymerizable, vinyl-based compound if other monomers or oligomers, for example non-reactive ones, are used in the ink-jet printer ink, for example as a filler or for a final curing after the main curing immediately after printing, in which case it is also possible for these monomers or oligomers not to be bonded in the network formed by the, in particular self-cross linking, preferably radically self-cross linking, vinyl-based compounds.

The monomers and/or oligomers are added to the ink-jet printer ink in a total proportion in particular which is selected from a range of 15% by weight to 99% by weight. Below 15% by weight, it is still possible for the formulated ink to harden but the mechanical resistance of the ink layers obtained is not satisfactory for practical applications. Above 99% by weight, no further improvement is observed in terms of the stability or abrasion resistance of the ink.

The monomers and/or oligomers may also be added to the ink-jet printer ink in a total proportion selected from a range of 25% by weight to 90% by weight or selected from a range of 25% by weight to 70% by weight.

In order to produce colorless inks (varnish), it is preferable to use formulations with a higher total proportion by weight of these monomers and oligomers, selected from a range of 80% by weight to 99% by weight. These ink-jet printer inks usually contain no proportion of pigment or dye, which means that the proportion of monomers or oligomers can be increased, thereby imparting better mechanical properties to the printed image.

For the vinyl-based compounds, it is preferable to use compounds from the group comprising vinyl esters, vinyl carbonates, vinyl carbamates, as well as derivatives thereof and mixtures thereof. In particular, these vinyl compounds have proved to be particularly practical as a replacement for (meth)acrylate in terms of the mechanical properties of the printed image, in particular abrasion resistance, as well as the processability of the inks in terms of adhesion of the printed image and curing times. These compounds also have advantageous properties with regard to bio-compatibility.

A further improvement to these properties of the ink-jet printer ink and the printed image was obtained by using several vinyl-based compounds comprising a mixture of vinyl butyrate, vinyl neodecanoate, vinyl stearate, vinyl benzoate, vinyl laurate and N-vinyl caprolactam, or, based on another embodiment of the ink-jet printer ink, several vinyl-based compounds comprising a mixture of vinyl neodecanoate, vinyl benzoate, vinyl laurate, vinyl carbonate-functionalized furfuryl and N-vinyl caprolactam or, based on another embodiment of the ink-jet printer ink, several vinyl-based compounds comprising a mixture of vinyl neodecanoate, vinyl benzoate, vinyl laurate, vinyl carbonate-functionalized 3-morpholino-1,2-propane diol and vinyl carbonate-functionalized furfuryl, and, based on another embodiment of the invention, the several vinyl-based compounds are contained in the ink-jet printer ink in at least approximately equimolar proportions.

The at least one vinyl-based compound may also have, in addition to the vinyl group, at least one non-vinyl additional functional group, which preferably comprises a glycol radical or a furfuryl group. Other possible groups are morpholines, bisphenols, alkyls, etc., as described below in connection with the independent synthesis of vinyl-based compounds. In particular, the at least one vinyl-based compound is mono-, di-, tri-, tetra-, penta- or hexa-functionalized in terms of the degree of vinylation. This enables an improvement to be obtained as regards the ink rheology, such as surface tension or viscosity, and an improvement in the adhesion to the substrate. This additionally enables the degree of cross-linking to be better controlled during curing. It also enables the physical properties of cured ink layers to be controlled, e.g. mechanical abrasion, resistance to solvent, polarity, etc. The particular advantage of this is that because of the additional functionalization, no other additives or only a small proportion of extra additives to the ink-jet printing ink are needed, and the covalent bonding of the constituent substances of the ink enables a further improvement in the bio-compatibility of the ink-jet printing ink to be obtained due to a reduction in potentially extractable substances.

In order to improve the dispersion capacity of the constituents of the ink-jet printer ink, it may contain at least one surfactant in a proportion selected from a range of 0.5% by weight to 25% by weight. Below 0.5% by weight, no improvement in this property was observed. Above 25% by weight, on the other hand, the wettability of the surface to be printed is made worse if it is not absorbent. Furthermore, higher proportions of surfactant have a detrimental effect on the drying speed of the ink.

The surfactant content may also be in a proportion selected from a range of 1.5% by weight to 20% by weight or in a proportion selected from a range of 1.5% by weight to 15% by weight.

The ink-jet printer ink may contain least one anti-foaming agent in a proportion selected from a range of 0.1% by weight to 10% by weight, the upper limit of 10% by weight ensuring that any undesired substrate wetting phenomena are avoided.

The content of anti-foaming agent may also be a proportion selected from a range of 0.5% by weight to 8% by weight or a proportion selected from a range of 1.5% by weight to 5% by weight.

As explained above, the ink-jet printer ink may contain at least one initiator, in particular a photoinitiator, in order to shorten or trigger polymerization of the monomers or oligomers. The initiator content may be in a proportion selected from a range of 0.1% by weight to 25% by weight and is preferably a derivative of di- and triacryloylhydroxylamine or a derivative of diacrylamide. Below 0.1% by weight, there would be some improvement but only to a limited degree. Above 25% by weight, the scratch resistance of the printed image can be further improved but this would mean increasing the initiator content, leading to a significant increase in cost which is not justified by the advantage gained.

The initiator content may also be a proportion selected from a range of 1.5% by weight to 20% by weight or a proportion selected from a range of 1.5% by weight to 15% by weight.

Based on one embodiment in this respect, a proportion of the initiator may be replaced by at least one other photoinitiator and/or a thermal initiator comprising molecules which remain unbonded in the ink after polymerization of the at least one vinyl-based compound. Accordingly, photoinitiating monomers may be incorporated in the ink proposed by the invention as a mixture with UV and/or thermal initiators used as standard in inks. These initiator mixtures enable the degree of cross-linking of the ink-jet printer ink to be increased. At the same time, however, the quantities of commercial UV and/or thermal initiator can be reduced, which in turn enables initiator decomposition products in the cured ink layers to be minimized

Based on another embodiment of this invention, it may be that only commercial photoinitiators and/or thermal initiators are used, i.e. without admixing covalently bondable initiators.

To provide a clearer understanding, the invention will be explained in more detail on the basis of the examples set out below.

Firstly, it should be pointed out that individual features or combinations of features from the different examples of embodiments described may constitute independent solutions proposed by the invention in their own right. Furthermore, the following descriptions of the ink-jet ink should be understood as meaning that the ink-jet ink contains, in addition to the vinyl-based compound(s), additives such as surfactants, anti-foaming agents, pigments, dyes, initiators, which are used in combination with the vinyl-based compound(s) respectively in a proportion selected from the ranges specified below.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

The inks used for ink-jet printing are ink mixtures which can be cured, usually by UV, thermal or electron radiation, and which are usually made up of carrier fluids, surfactants, binding agents, dyes and pigments.

The inks used for ink-jet applications are usually produced in several stages of separate process steps. Of these, grinding of the pigment and producing the associated pigment dispersion is generally a separate but very critical production step, but formulation of the full ink, i.e. the addition of reactive monomers, viscositys regulators, binding agents, initiators, etc., may also take place in several stages. The formulation procedures involved and the equipment used for these correspond to those known from the relevant prior art. To avoid unnecessary repetition at this point, reference may be made to the relevant technical literature.

In this connection, this invention firstly specifies the use of monomers or oligomers, comprising exclusively at least one vinyl-based compound, in particular vinyl esters and/or vinyl carbonates and/or vinyl carbamates or derivatives thereof or mixtures thereof as an ink base for producing ink-jet printer inks befor these vinyl-based compounds are provided with additional functional groups (e.g. glycol radicals, furfuryl radicals, morpholine radicals, bisphenol radicals, alkyl radicals, etc.) in order to control the ink rheology, adhesion to the substrate, ink resistance, etc.

The expression “vinyl-based compound” within the meaning of the invention should be construed as a chemical compound containing at least one vinyl group in the molecule. In particular, it should be understood as including vinyl esters, vinyl carbonates and vinyl carbamates or derivatives thereof and mixtures thereof.

Depending on the degree of vinylation in each case, monofunctional vinyl esters, vinyl carbonates and vinyl carbamates may be described by the following structural formulas:

vinyl esters: R—COO—CH═CH₂

vinyl carbonates: R—OCOO—CH═CH₂

vinyl carbamates: R,R′N—COO—CH═CH₂

In the above, the radicals R and R′ stand in particular for glycol radicals, furfuryl radicals, morpholine radicals, bisphenol radicals, alkyl radicals and the groups described below for independently synthesizing vinyl-based compounds.

In addition to these monofunctional vinyl-based compounds, vinyl esters, vinyl carbonates and vinyl carbamates to which multiple functions have been imparted in terms of the degree of vinylation may also be used, preferably di-, tri-, tetra-, penta- or hexafunctionalized, in which case additional vinyl groups may be disposed at the end or in a side chain in the molecule. Examples of these are vinyl esters, vinyl carbonates and vinyl carbamates produced from 1,6-hexane diol, 1,3-propane diol, 2-benzyloxy-1,3-propane diol, and many more, these being the product of the independent synthesis of vinyl-based compounds described below.

Compared with conventional acrylate or methacrylate systems, the invention is distinctive due to the fact that from the vinyl-based monomers and from the oligomers derived from them, it is possible to obtain inks which cure rapidly (in a manner comparable with acrylate or methacrylate inks), and the bio-compatibility of the ink or print, especially if using vinyl esters, vinyl carbonates and vinyl carbamates, is significantly higher (depending on the monomer up to 100-times higher bio-compatibility), the odor of the inks and ink layers can be reduced and—depending on the ink composition—ink layers with advantageous mechanical properties can be obtained (e.g. up to 2-times higher modulus of elasticity, a hardness comparable with acrylate or methacrylate inks, etc.).

The ink-jet printer ink proposed by the invention may contain up to 99% by weight of at least one vinyl-based compound, in particular at least one vinyl ester, at least one vinyl carbonate or at least one vinyl carbamate, as well as derivatives thereof, and also mixtures of the individual categories of material may be used, and it is possible that of these, as described above, a proportion of up to 35% by weight, in particular 30% by weight, preferably 20% by weight, may be replaced by monomers or oligomers that are not vinyl-based.

The ink-jet printer inks proposed by the invention may also contain various dyes and/or pigments in proportions of up to 45% by weight, surfactants up to 25% by weight, anti-foaming agent up to 10% by weight as well as initiators (UV initiators and/or thermal initiators) in proportions of up to 10% by weight, and may be made from these constituents in addition to the vinyl-based compound(s).

The inks proposed by the invention are preferably made from commercially available products, including for example vinyl-4-tert-butyl benzoate, vinyl cinnamate, vinyl crotonate, vinyl decanoate, vinyl pivalate, vinyl trifluoroacetate, vinyl acetate, vinyl propionate, vinyl butyrate, vinyl neodecanoate, vinyl stearate, vinyl benzoate, vinyl laurate, which can be obtained from suppliers such as Sigma-Aldrich.

In addition to these commercial compounds, the inks proposed by the invention also contain separately synthesized vinyl-based compounds, which can be obtained by reacting alcohols, carbohydrates, glycols, polyesters, carboxylic acids, fatty acids, amines, amino acids, proteins, polyurethanes, silicones, etc., with appropriate reagents, as described in the reference literature listed below, in particular to obtain vinyl esters, vinyl carbonates and vinyl carbamates. The procedures used for synthesis are described in detail in the relevant background literature, for example in Hurd, C. D.; Roach, R.; Huffman, C. W. J. Am. Chem. Soc. 1956, 78, 104, or Lobell, M.; Schneider, M. P. Synthesis 1994, 375. or Lee, T. Y.; Guymon, C. A.; Jonsson, E. S.; Hait, S.; Hoyle, C. E. Macromolecules 2005, 38, 7529, or Atta, A. M.; El-Saeed, S. M.; Farag, R. K. React. & Funct. Polym. 2006, 66, 1596, or WO 200100634 Al, or Rohr, M.; Geyer, C.; Wandeler, R.; Schneider, M. S.; Murphy, E. F.; Baiker, A. Green Chemistry 2001, 3, 123.

In order to synthesize the corresponding vinyl esters, it is preferable to use vinyl carbonates and vinyl carbamates as starting materials which impart a particular effect in the ink, e.g. as viscosity regulators, surfactants, anti-foaming agents, dispersing agents, agents to improve adhesion, etc. The following are used to this end in particular: ethylene glycols, propylene glycols, neopentyl glycols, 1,1′-methylene-di(2-naphthol), 1,1,1-tris(4-hydroxyphenyl)ethane, 1,14-tetradecane diol, 1,2,4-benzene triol, 1,2-benzene dimethanol, 1,2-decane diol, 1,2-pentane diol, 1,2-tetradecane diol, 1,3-dioxan-5,5-dimethanol, 1,3-propane diol, 1,4-bis(2-hydroxyisopropyl)benzene, 1,5-hexadien-3,4-diol, 1,6-dihydroxynaphthalene, 1,6-hexane diol, 1-(2-nitrophenyl)-1,2-ethane diol, 1-(benzyloxymethyl)tri(ethylene glycol), 1-[N,N-bis(2-hydroxyethyl)amino]-2-propanol, 2,2′-(o-phenylene dioxy)diethanol, 2,2′-biphenyldimethanol, 2,2′-bipyridine-3,3′-diol, 2,2,3,3,4,4,5,5-octafluoro-1,6-hexane diol, 2,2,4-trimethyl-1,3-pentane diol, 2,2-bis(bromomethyl)-1,3-propane diol, 2,2-bis(hydroxymethyl)butyric acid, 2,3,5,6-tetramethyl-p-xylene-α,α′-diol, 2,3-dibromo-1,4-butane diol, 2,3-dichloro-5,8-dihydroxy-1,4-naphthoquinone, 2,4-dimethyl-2,4-pentane diol, 2,5-dibromohydroquinone, 2,5-dihydroxy-1,4-benzoquinone, 2,5-dimethylresorcinol, 2,6-dihydroxy-4-methyl-3-pyridine carbonitrile, 2,7-dimethyl-3,5-octadiyne-2,7-diol, 2-(bromomethyl)-2-(hydroxymethyl)-1,3-propane diol, 2-benzyloxy-1,3-propane diol, 2-hydroxyethyldisulfide, 2-hydroxymethyl-1,3-propane diol, 2-methyl-1,3-propane diol, 2-methylene-1,3-propane diol, 2-nitroresorcinol, 2-phenyl-1,2-propane diol, 3′,5′-dihydroxyacetophenone, 3,3′-(ethylenedioxy)diphenol, 3,3,3′,3′-tetramethyl-1,1′-spirobiindan-5,5′,6,6′-tetraol, 3,3-dimethyl-1,2-butane diol, 3-(4-methoxyphenoxy)-1,2-propane diol, 3-bromo-1,2-propane diol, 3-cyclohexene-1,1-dimethanol, 3-ethoxy-1,2-propane diol, 3-fluorocatechol, 3-hexyne-2,5-diol, 3-methoxy-1,2-propane diol, 3-methyl-1,3,5-pentane triol, 3-morpholino-1,2-propane diol, 3-phenoxy-1,2-propane diol, 3-piperidino-1,2-propane diol, 4,4′-dihydroxybenzophenone, 4,4′-isopropylidene-to[2-(2,6-dibromophenoxy)ethanol], 4,4′-isopropylidene dicyclohexanol, 4,6-dinitropyrogallol, 4-amino-4-(3-hydroxypropyl)-1,7-heptane diol, 4-bromo-3,5-dihydroxybenzoic acid, 4-tert-butylcalix[4]arene, 5-chloro-2,3-pyridine diol, 7,8-dihydroxy-6-methoxycoumarine, 7-octene-1,2-diol, anthrarufin, bis(2-hydroxyethyl)terephthalate, chlorohydroquinone, di(trimethylolpropane), diethyl-2,5-dihydroxyterephthalate, diethyl-to(hydroxymethyl)malonate, hydrobenzoin, hydroquinon-to(2-hydroxyethyl)ether, methyl-3,4,5-trihydroxybenzoate, N,N,N′,N′-tetrakis(2-hydroxypropyl)ethylene diamine, nitromethane trispropanol, pentaerythritol, tetrafluorohydroquinone, triisopropanolamine, 1,3,5-cyclohexane triol, 1,2-cyclopentane diol, tert-butylhydroquinone, 1,2-cyclohexane diol, 1,4-dioxan-2,3-diol, 2,3-dibromo-2-butene-1,4-diol, trans-p-menth-6-ene-2,8-diol, 2,2′-biphenol, 3,3′,5,5′-tetrabromotophenol A, 4,4′-(1,3-phenylene diisopropylidene)tophenol, 4,4′-(1,4-phenylene diisopropylidene)tophenol, 4,4′-(1-phenylethylidene)tophenol, 4,4′-(9-fluorenylidenediphenol, 4,4′-(hexafluoroisopropylidene)diphenol, 4,4′-cyclohexylidene tophenol, 4,4′-ethylidene tophenol, 4,4′-isopropylidene-to(2,6-dimethylphenol), 4,4′-dihydroxybiphenyl, 4,4′-methylene-to(2,6-di-tert-butylphenol), 4,4′-sulfonylto(2-methylphenol), 4,4′-sulfonyldiphenol, 4,4′-thiodiphenol, bis[4-(2-hydroxyethoxy)phenyl]sulfone, bisphenol A, ethoxylated bisphenol A, propoxylated bisphenol A, bisphenol C, 1,2,4,5-benzene tetracarboxamide, 1,2-diaminocyclohexane, 1,3-cyclohexane-to(methylamine), 1,4-diaminoanthraquinone, 1,5-diamino-2-methylpentane, 1,9-diaminononane, 2,2′-(ethylene dioxy)to(ethylamine), 2,2-dimethyl-1,3-propane diamine, 2,3,5,6-tetramethyl-p-phenylene diamine, 2,4,6-trimethyl-m-phenylene diamine, 2,4,8,10-tetraoxaspiro[5.5]undecan-3,9-dipropanamine, 2,4-diaminotoluene, 2,5-dichloro-p-phenylene diamine, 2,5-dimethyl-1,4-phenylene diamine, 2,6-diaminopurine, 2,6-diaminotoluene, 2-aminophenyldisulfide, 3,3′-methylene dianiline, 3,4′-oxydianiline, 3,4-diaminobenzophenone, 4,4′-(1,1′-biphenyl-4,4′-diyldioxy)dianiline, 4,4′-(1,3-phenylene diisopropylidene)toaniline, 4,4′-(1,3-phenylene dioxy)dianiline, 4,4′-(1,4-phenylene diisopropylidene)toaniline, 4,4′-(4,4′-isopropylidene diphenyl-1,1′-diyldioxy)dianiline, 4,4′-(hexafluoroisopropylidene)to(p-phenyleneoxy)dianiline, 4,4′-(hexafluoroisopropylidene)dianiline, 4,4′-diaminobenzophenone, 4,4′-diaminooctafluorobiphenyl, 4,4′-methylene-to(cyclohexylamine), 4,4′-diaminobenzanilide, 4,4′-methylene-to(2-chloroaniline), 4,4′-methylene-to(2,6-diethylaniline), 4,4′-methylene-to(2,6-dimethylaniline), 4,7,10-trioxa-1,13-tridecane diamine, 4,9-dioxa-1,12-dodecane diamine, 4-aminophenyldisulfide, 4-chloro-o-phenylene diamine, 5,5′-(hexafluoroisopropylidene)di-o-toluidine, 6-chloro-3,5-diamino-2-pyrazine carboxamide, Dytek®-EP-diamine, poly(l,4-butane diol)to(4-aminobenzoata), tris(2-aminoethyl)amine, p-xylylene diamine, 1,4,8,11-tetraazacyclotetradecane-5,7-dione, 1,4,8,12-tetraazacyclopentadecane, 1,5,9-triazacyclododecane, cyclene, N,N′-diisopropyl-1,3-propane diamine, N,N′-diisopropylethylene diamine, N,N′-diphenyl-p-phenylene diamine, N,N′-diethyl-2-butene-1,4-diamine, N,N′-dimethyl-1,3-propane diamine, 1-[bis[3-(dimethylamino)propyl]amino]-2-propanol, 2-[2-(dimethylamino)ethoxy]ethanol, 1,1-cyclohexane diacetic acid, 1,2,3,4-butane tetracarboxylic acid, 1,2,3-triazol-4,5-dicarboxylic acid, 1,3,5-cyclohexane tricarboxylic acid, 1,3-acetone dicarboxylic acid, 1,3-adamantane triacetic acid, 1,3-cyclohexane dicarboxylic acid, 1,4-naphthalene dicarboxylic acid, 1,4-phenylene dipropionic acid, 2,2′-bipyridine-4,4′-dicarboxylic acid, 2,2′-iminodibenzoic acid, 2,3-dibrombutane dioic acid, 2,5-dihydroxyterephthalic acid, 2,6-dimethyl-3,5-pyridine dicarboxylic acid, 2,6-naphthalene dicarboxylic acid, 2-(2-methoxyethoxy) acetic acid, 2-bromoterephthalic acid, 2-methoxyisophthalic acid, 2-[2-(2-methoxyethoxy)ethoxy] acetic acid, 3,4-dihydroxyhydrocinnamic acid, 3-fluorophthalic acid, 3-phenylglutaric acid, 3-thiophene malonic acid, 4,4′-oxyto(benzoic acid), 4,4′-sulfonyldibenzoic acid, 4,5-dichlorophthalic acid, 4-methylphthalic acid, 5-(octadecyloxy)isophthalic acid, 5-tert-butylisophthalic acid, 6-methylpyridine-2,3-dicarboxylic acid, 1,7-heptane dicarboxylic acid, benzylmalonic acid, biphenyl-4,4′-dicarboxylic acid, bis(carboxymethyl)trithiocarbonate, butylmalonic acid, chlorobutane diacetic acid, cyclohexylbutane diacetic acid, dibromomaleic acid, diethylmalonic acid, dodecane diacetic acid, ethylmalonic acid, hexadecane diacetic acid, 2-methyl-2-butene diacetic acid, perfluoroglutaric acid, phenylmalonic acid, terephthalic acid, tetrafluorophthalic acid, undecane diacetic acid, p-terphenyl-4,4″-dicarboxylic acid, 1,6-hexane diacetic acid, etc.

As may be gleaned from the starting materials listed above, the resultant vinyl esters, vinyl carbonates and vinyl carbamates may be, in terms of their degree of vinylation, both mono-, di-, tri-, tetra-, penta- or hexa-functionalized. Higher functionalizede vinyl esters, vinyl carbonates and vinyl carbamates are used as a means of controlling the degree of cross-linking of the ink. This enables the mechanical resistance, resistance to solvent, etc., to be influenced for example.

These starting materials and to some extent commercial vinyl esters, vinyl carbonates and vinyl carbamates derived from them may be obtained from commercial suppliers, for example Sigma-Aldrich, Fluka, AB CR, etc.

In addition to the compounds mentioned above, it is also possible to use all other suitable alcohols, carbohydrates, glycols, polyesters, carboxylic acids, fatty acids, amines, amino acids, proteins, polyurethanes, silicones, etc., to synthesize vinyl esters, vinyl carbonates and vinyl carbamates.

In special cases, it is also possible to produce water-soluble vinyl esters, vinyl carbonates and vinyl carbamates if the starting materials used have a sufficiently high degree of alkoxylation, in other words a degree of alkoxylation based on at least two ethylene glycol or propylene glycol groups, preferably three to twelve ethylene glycol or propylene glycol groups.

All of the compounds listed above may be used either as pure components or in any mixtures to formulate ink-jet printer inks.

The ink-jet printer ink proposed by the invention is formulated in particular from vinyl esters, vinyl carbonates and/or vinyl carbamates in a total proportion selected from a range with a lower limit of 15% by weight and an upper limit of 99% by weight. Formulations based on weight proportions of vinyl esters and/or vinyl carbonates and/or vinyl carbamates of 80% by weight to 99% by weight are used primarily to produce colorless inks (varnish). At this stage, it should be pointed out that although a total content of the at least one vinyl-based compound of 99% by weight in the ink-jet printer ink is possible, it was found that using vinyl esters and/or vinyl carbonates and/or vinyl carbamates in excess of 90% by weight in the ink-jet printer ink brought no further improvement in terms of the stability or abrasion resistance of the ink-jet printer ink.

In addition to assuming the function of binding agent and forming the matrix, i.e. of the ink network, the vinyl-based compounds, in particular vinyl esters, vinyl carbonates and vinyl carbamates, can also assume various other functions, including imparting the effect of a surfactant and a reagent to ensure adhesion to the substrate, etc.

Examples of vinyl-based compounds which have a surfactant and dispersing effect are glycol- or polyester-functionalized vinyl esters, vinyl carbonates and vinyl carbamates.

Examples of vinyl-based compounds with an anti-foaming agent effect are silicone-functionalized vinyl esters, vinyl carbonates and vinyl carbamates.

Examples of vinyl-based compounds which act as viscosity regulators are glycol-, polyester- and polyurethane-functionalized vinyl esters, vinyl carbonates and vinyl carbamates.

Examples of vinyl-based compounds which have the effect of improving adhesion are morpholine-, glycol- or furfuryl-functionalized vinyl esters, vinyl carbonates and vinyl carbamates.

Pigments and/or dyes are used in the ink-jet printer inks proposed by the invention as color-imparting constituents, and may be added to the ink individually or as a mixture. The pigments and dyes are primarily organic materials but may also be inorganic special pigments or fillers (e.g. titanium oxides, hydroxyapatites, etc.). Such pigments and dyes are known from the relevant prior art, for example under the name of the CMYK color model.

The pigments and dyes and any mixtures thereof may be added to the ink-jet printer ink proposed by the invention in a proportion of 0.2% by weight to 45% by weight, in particular 2.5% by weight to 30% by weight.

The pigments and dyes are commercially available.

Yet another component which the ink-jet printer ink proposed by the invention may contain is at least one photoinitiator, in particular at least one UV-initiator, and/or a thermal initiator. Examples of these are various Irgacure® initiators, various Darocure® initiators, phenones, benzoins, etc., or azotoisobutyronitrile, 1, l′-azoto(cyclohexane carbonitrile), t-butylhydroperoxide, m-chloroperbenzoic acid, dibenzoylperoxide, di-t-butylperoxide, etc. The initiators used in this connection correspond to those known from the prior art and reference may therefore be made to the relevant technical literature.

This initiator or an initiator mixture thereof may be based in a proportion of 0.2% by weight to 10% by weight, in particular 0.5% by weight to 8% by weight.

These initiators are commercially available and may be obtained from Sigma-Aldrich, CIBA, Fluka, etc., for example.

The ink-jet printer ink proposed by the invention may also contain at least one other surfactant which, unlike the vinyl-based compounds with a surfactant function listed above, is not covalently bonded in the ink network. Surfactants which might be used include anionic, cationic, non-ionic or ampholytic surfactants or mixtures thereof.

Examples of anionic surfactants are surfactants incorporating carboxylate, sulfate, phosphate or sulfonate groups, such as, for example, amino acid derivatives, fatty alcohol ether sulfates, fatty alcohol sulfates, soaps, alkylphenolethoxylates, fatty alcohol ethoxylates, but also alkane sulfonates, olefin sulfonates or alkyl phosphates. Exampls of non-ionic surfactants are ethoxylates, such as, for example, ethoxylated addition products of alcohols, such as, for example, polyoxyalkylene polyols, amines, fatty acids, fatty acid amides, alkyl phenols, ethanolamides, fatty amines, polysiloxanes or fatty acid esters, but also alkyl or alkylphenyl polyglycol ethers, such as, for example, fatty alcohol polyglycol ether, or fatty acid amides, alkyl glycosides, saccharic radicals, sorbitan esters, polysorbates or trialkylamine oxides, but also esters and amides of poly(meth)acrylic acids with polyalkylene glycols or amino polyalkylene glycols, all of which may terminate at one end with alkly groups. Examples of cationic surfactants are quaternary ammonium or phosphonium compounds, such as, for example, tetraalkyl ammonium salts, N,N-dialkylimidazoline compounds, dimethyldistearyl ammonium compounds, or N-alkylpyridine compounds, and in particular ammonium chlorides. Ampholytic surfactants include amphoteric electrolytes, so-called ampholytes, such as, for example, amino carboxylic acids and betaines.

The proportion of these surfactants may be selected from a range of 0.5% by weight to 25% by weight, in particular from a range of 1.5% by weight to 20% by weight, or selected from a range of 1.5% by weight to 15% by weight.

Such surfactants are widely available commercially and can be obtained form Sigma-Aldrich, for example.

Since different ink mixtures based on vinyl esters, vinyl carbonates and vinyl carbamates have a tendency to form foam during the ink-jet process, the ink-jet printer ink proposed by the invention may contain at least one added anti-foaming agent with a silicone base if necessary, for example commercially available silicone oils or poly(dimethyl siloxane). The quantity of anti-foaming agent in the ink formulation is preferably reduced to a minimum in order to avoid undesired substrate wetting phenomena.

The at least one anti-foaming agent may be added in a total proportion of 0.1% by weight to 10% by weight or in a total proportion of 0.5% by weight to 8% by weight or in a total proportion of 1.5% by weight to 5% by weight.

This anti-foaming agent may be obtained from CIBA or Sigma-Aldrich, for example.

The ink-jet printer inks formulated on the basis of vinyl-based compounds, in particular on the basis of vinyl esters and/or vinyl carbonates and/or vinyl carbamates, may also contain new types of photoinitiating monomers as “UV-initiators”. These compounds, which are derived from derivatives of di- and triacryloylhydroxyl amines or derivatives of diacrylamide for example, are described in sufficient detail in the relevant technical literature relating to initiators, e.g. in Lee, T. Y.; Guymon, C. A.; Jonsson, E. S.; Hait, S.; Hoyle, C. E. Macromolecules 2005, 38, 7529, or Karasu, F.; Dworak, C.; Kopeinig, S.; Hummer, E.; Arsu, N.; Liska, R. Macromolecules 2008, 41, 7953, or Dworak, C.; Kopeinig, S.; Hoffmann, H.; Liska, R. J. Polym. Sci., Part A: Polym. Chem. 2008, 47, 392, but not in connection with ink-jet applications. The advantage of using these compounds in ink-jet printer inks resides in the fact that they initiate photopolymerization and are bonded in the ink network. Due to this covalent bonding of the initiator, no extractable initiator decomposition products (e.g. phosphine oxides, etc.) are left in the ink layer which, in biological applications for example, can lead to alltergiv reactionse.

These photoinitiating monomers may be used in a proportion of 0.1% by weight to 25% by weight, or in a proportion of 1.5% by weight to 20% by weight or in a proportion von 1.5% by weight to 15% by weight, and it would also be possible to use any mixture with commercial UV and/or thermal initiators, as described above, in other words initiators which are not covalently bonded. If photoinitiating monomers are used as a mixture with commercial UV and/or thermal initiators in the ink-jet printer ink proposed by the invention, this will increase the degree of cross-linking of the ink-jet printer inks. At the same time, the quantities of commercial UV and/or thermal initiators can be reduced as a result, which in turn enables initiator decomposition products in the cured ink layers to be minimized as a result.

These photoinitiating monomers are not currently commercially available but can be prepared on the basis of the published synthesis processes mentioned above. In this connection, it should be pointed out that water-soluble derivatives are also accessible by opting for an appropriate degree of alkoxylation of the photoinitiating monomer.

Preferred examples of the approach proposed by the invention to producing ink-jet printer inks with a base of vinyl esters, vinyl carbonates and vinyl carbamates will be discussed below. Due to the numerous possibilities in terms of embodiments of the invention, only a few examples are given here, since the scope of the description would otherwise be excessively long.

The embodiments illustrated as examples represent a few possible variants and it should be pointed out at this stage that the invention is not specifically limited to the variants specifically described, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

### EXAMPLE 1

A commercial soot dispersion was added to an equimolar mixture of vinyl butyrate, vinyl neodecanoate, vinyl stearate, vinyl benzoate, vinyl laurate and N-vinyl caprolactam, so that a soot content of 6% by weight was obtained. In order to control the ink rheology, a mixture of high-molecular vinyl carbonates of ethylene glycol and propylene glycol (both mono- and di-functionalized) were used. To enable UV curing of this ink-jet-ink, 1.5% by weight of 2-hydroxy-2-methylpropiophenone, 0.5% by weight of Irgacure 819 and 1% by weight of benzophenone were added.

### EXAMPLE 2

A commercial soot dispersion was added to an equimolar mixture of vinyl butyrate, vinyl neodecanoate, vinyl stearate, vinyl benzoate, vinyl laurate and N-vinyl caprolactam so that as soot content of 6% by weight was obtained. In order to control the ink rheology, a mixture of high-molecular vinyl carbonates of ethylene glycol and propylene glycol (both mono- and di-functionalized) was used. To enable thermal curing of this ink-jet-ink, 1.5% by weight of azotoisobutyronitrile and 1% by weight of dibenzoyl peroxide were added.

### EXAMPLE 3

A commercial dispersion of copper phthalocyanine was added to an equimolar mixture of vinyl neodecanoate, vinyl benzoate, vinyl laurate, vinyl carbonate-functionalized furfuryl and N-vinyl caprolactam so that a pigment proportion of 5% by weight was obtained. In order to control the ink rheology, a mixture of high-molecular vinyl carbonates and vinyl carbamates of ethylene glycol and propylene glycol (both mono- and di-functionalized) was used. To cure this ink-jet-ink, a mixture of 0.5% by weight of azotoisobutyronitrile, 0.2% by weight of dibenzoyl peroxide and 1.5% by weight of 2-hydroxy-2-methylpropiophenone was added.

### EXAMPLE 4

A commercial dispersion of titanium oxide was added to an equimolar mixture of vinyl neodecanoate, vinyl benzoate, vinyl laurate, vinyl carbonate-functionalized 3-morpholino-1,2-propane diol and vinyl carbonate-functionalized furfuryl so that a pigment proportion of 9% by weight was obtained. In order to control the ink rheology, a mixture of high-molecular vinyl carbonates of ethylene glycol and propylene glycol (both mono- and di-functionalized) as well as non-functionalize polyethylene glycol were used. In order to cure this ink-jet-ink, a mixture of 0.5% by weight of azotoisobutyronitrile and 2.5% by weight of 2-hydroxy-2-methylpropiophenone was added.

### EXAMPLE 5

Added to an equimolar mixture of vinyl butyrate, vinyl neodecanoate, vinyl stearate, vinyl benzoate, vinyl laurate and N-vinyl caprolactam in order to control the ink rheology was a mixture of high-molecular vinyl carbonates of ethylene glycol and propylene glycol (both mono- and di-functionalized). To enable UV curing of this colorless ink-jet-ink, 0.5% by weight of 2-hydroxy-2-methylpropiophenone and 4% by weight of O,N,N-tris(carboxy-2-phenyl)hydroxylamine were added.

### EXAMPLE 6

Commercial bromochlorophenol Blue was added to an equimolar mixture of vinyl neodecanoate, vinyl benzoate, vinyl laurate, vinyl carbonate-functionalized furfuryl and N-vinyl caprolactam so that a saturated dye solution was obtained. After filtering off any solid residues, a mixture of high-molecular vinyl carbonates and vinyl carbamates of ethylene glycol and propylene glycol (both mono- and di-functionalized) was used in order to control the ink rheology. To cure this ink-jet-ink, a mixture of 0.5% by weight of azotoisobutyronitrile, 0.2% by weight of dibenzoyl peroxide and 1.5% by weight of 2-hydroxy-2-methylpropiophenone was added.

### EXAMPLE 7

A commercial dispersion of a magenta-colored pigment was added to a mixture of high-molecular vinyl esters and vinyl carbonates of ethylene glycol and propylene glycol (both mono- and di-functionalized in a mixing ratio of 1:3). To enable UV curing of this ink-jet-ink, 1.5% by weight of Irgacure 819 was added.

### EXAMPLE 8

A commercial dispersion of a yellow pigment was added to a mixture of vinyl carbonate-functionalized derivative of 1,6-Hexane diol, 1,2-tetradecane diol, 2,2,4-trimethyl-1,3-pentane diol, 3-morpholino-1,2-propane diol and ethoxylated bisphenol A (mixing ratio: 1:2.5:0.7:3:5). To enable UV curing of this ink-jet-ink, 1.5% by weight of 2-hydroxy-2-methylpropiophenone and 1% by weight of benzophenone were added.

### EXAMPLE 9

A commercial dispersion of a cyan-colored pigment was added to a mixture of vinyl ester-functionalized derivative of 1,3-adamantane diacetic acid, 1,3-cyclohexane dicarboxylic acid and dodecane diacetic acid (mixing ratio: 1:0.2:3). In order to adjust the ink rheology, vinyl carbonate-functionalized, ethoxylated bisphenol A was used. To cure this ink-jet-ink, a mixture of 0.5% by weight of azotoisobutyronitrile and 2.5% by weight of 2-hydroxy-2-methylpropiophenone was added.

1. Ink-jet printer ink comprising polymerizable monomers and/or oligomers and optionally at least one initiator, wherein the monomers and/or oligomers are formed at least up to 65% by weight, preferably exclusively, by at least one, preferably radically polymerizable, vinyl-based compound, or the monomers and/or oligomers are formed at least partially, preferably exclusively, by at least one vinyl-based compound and the initiator is formed by monomers which react with the at least one vinyl-based compound during the polymerization thereof to form a covalent bond therewith.

2. Ink-jet printer ink according to claim 1, wherein the total proportion of monomers and/or oligomers is selected from a range of 15% by weight to 99% by weight.

3. Ink-jet printer ink according to claim 2, wherein the total proportion of monomers and/or oligomers is selected from a range of 80% by weight to 99% by weight.

4. Ink-jet printer ink according to one of claims 1 to 3, wherein the at least one vinyl-based compound is selected from the group comprising vinyl esters, vinyl carbonates, vinyl carbamates, as well as derivatives thereof and mixtures thereof.

5. Ink-jet printer ink according to one of claims 1 to 3, wherein it contains several vinyl-based compounds comprising a mixture of vinyl butyrate, vinyl neodecanoate, vinyl stearate, vinyl benzoate, vinyl laurate and N-vinyl caprolactam.

6. Ink-jet printer ink according to one of claims 1 to 3, wherein it contains several vinyl-based compounds comprising a mixture of vinyl neodecanoate, vinyl benzoate, vinyl laurate, vinyl carbonate-functionalized furfuryl and N-vinyl caprolactam.

7. Ink-jet printer ink according to one of claims 1 to 3, wherein it contains several vinyl-based compounds comprising a mixture of vinyl neodecanoate, vinyl benzoate, vinyl laurate, vinyl carbonate-functionalized 3-morpholino-1,2-propane diol and vinyl carbonate-functionalized furfuryl.

8. Ink-jet printer ink according to one of claims 5 to 7, wherein it contains the several vinyl-based compounds in at least approximately equimolar proportions.

9. Ink-jet printer ink according to one of claims 1 to 8, wherein the at least one vinyl-based compound has at least one additional functional group.

10. Ink-jet printer ink according to claim 9, wherein the at least one vinyl-based compound is mono-, di-, tri-, tetra-, penta- or hexa-functionalized in terms of the degree of vinylation.

11. Ink-jet printer ink according to claim 9 or 10, wherein the at least one additional functional group is formed by a glycol radical, a furfuryl-group, a morpholine radical or a bisphenol radical.

12. Ink-jet printer ink according to one of claims 1 to 11, wherein it contains at least one surfactant in a proportion selected from a range of 0.5% by weight to 25% by weight.

13. Ink-jet printer ink according to one of claims 1 to 12, wherein it contains at least one anti-foaming agent in a proportion selected from a range of 0.1% by weight to 10% by weight.

14. Ink-jet printer ink according to one of claims 1 to 13, wherein the photoinitiator is a derivative of di- and triacryloylhydroxylamine or a derivative of diacrylamide.

15. Ink-jet printer ink according to one of claims 1 to 14, wherein it contain the initiator in a proportion selected from a range of 0.1% by weight to 25% by weight.

16. Ink-jet printer ink according to one of claims 1 to 15, wherein a proportion of the initiator is replaced by at least one other photoinitiator and/or thermal initiator formed by molecules which remain unbonded in the ink after polymerization of the at least one vinyl-based compound.

17. Use of at least one vinyl compound from the group of polymerizable vinyl esters, vinyl carbonates, vinyl carbamates, as well as derivatives thereof and mixtures thereof, to produce an ink-jet printer ink formed at least up to 65% by weight, preferably exclusively, by at least one vinyl-based compound, in particular vinyl esters, vinyl carbonates, vinyl carbamates as well as derivatives thereof and mixtures thereof.
